(19) United States
(12) Patent Application Publication
(10) Pub. No.: US 2015/0030310 A1
(43) Pub. Date: Jan. 29, 2015

(54) INTELLIGENT VIEWING OF A TELEVISION PROGRAM SERIES USING METADATA

(71) Applicant: International Business Machines Corporation, Armonk, NY (US)

(72) Inventors: Pamela A. Nesbitt, Ridgefield, CT (US); Lisa Seacat DeLuca, Baltimore, MD (US)

(73) Assignee: International Business Machines Corporation, Armonk, NY (US)

(21) Appl. No.: 13/948,328

(22) Filed: Jul. 23, 2013

(51) Int. Cl. H04N 21/435; H04N 21/432

(52) U.S. Cl. CPC H04N 21/435; H04N 21/4325
USPC 386/239

(57) ABSTRACT

Embodiments of the present invention provide a system, method, and program product. In certain embodiments, a computing device monitors a viewing selection of an episode multimedia file, wherein the episode multimedia file is included as executable code on an optical disc, and wherein the episode multimedia file is associated with a television series. The computing device determines whether the episode multimedia file or a copy thereof has been previously executed by a computing device associated with the user of the monitoring computing device. The computing device transmits the episode multimedia file for display, in response to determining that the episode multimedia file or a copy thereof was not previously executed by the computing device associated with the user of the monitoring computing device. The computing device generates an action, in response to determining that the episode multimedia file or copy thereof was previously executed by the computing device.

### FIELD OF THE INVENTION

The present invention relates generally to the field of multimedia file playback, and more particularly to determining whether an episode of a television series was previously viewed.

### BACKGROUND OF THE INVENTION

Television series are routinely available for delivery to subscribers, for example, through an on-demand streaming media service or a DVD-by-mail service. A television series (hereinafter “series”) is a connected set of television program episodes that run under the same title, possibly spanning many seasons. Streaming media is multimedia that is constantly received by and presented to an end-user while being delivered by a provider, such as YouTube® and Netflix®. In such a delivery method, a client media player can begin playing the received data before the entire file has been transmitted. DVD-by-mail services, such as Netflix®, allow a person to rent television series that are recorded on optical discs, such as CD-ROM, DVD and Blu-Ray optical discs.

A series received through an on-demand streaming media service or a DVD-by-mail service typically includes metadata associated with the episodes and/or series, such as title, genre, and summary. A summary may be one sentence or up to a paragraph or two to provide a more complete description. Viewing of the one or more of the delivered episodes included on the optical disc includes the use of an optical disc reader that reads the executable code included and software capable of executing the executable code. In addition, viewing an episode included on a optical disc typically require the viewer to either remember the last episode viewed or begin viewing the delivered episodes to determine which episode(s) have not yet been viewed.

### SUMMARY

Embodiments of the present invention provide a system, method, and program product to determine whether an episode of a television series was previously viewed. In certain embodiments, a computing device monitors a viewing selection of an episode multimedia file, wherein the episode multimedia file is included as executable code on an optical disc, and wherein the episode multimedia file is associated with a television series. The computing device determines whether the episode multimedia file or a copy thereof has been previously executed by a computing device associated with the user of the monitoring computing device. The computing device transmits the episode multimedia file for display, in response to determining that the episode multimedia file or a copy thereof was not previously executed by the computing device associated with the user of the monitoring computing device. The computing device generates an action, in response to determining that the episode multimedia file or copy thereof was previously executed by the computing device.

### BRIEF DESCRIPTION OF THE SEVERAL VIEWS OF THE DRAWINGS

FIG. 1 is a block diagram illustrating an environment, in accordance with an embodiment of the present invention.

FIG. 2 is a flowchart depicting operational steps of a program function for determining whether an episode multimedia file has previously been played, in accordance with an embodiment of the present invention.

FIG. 3 depicts a block diagram of components of a computing device in accordance with an illustrative embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

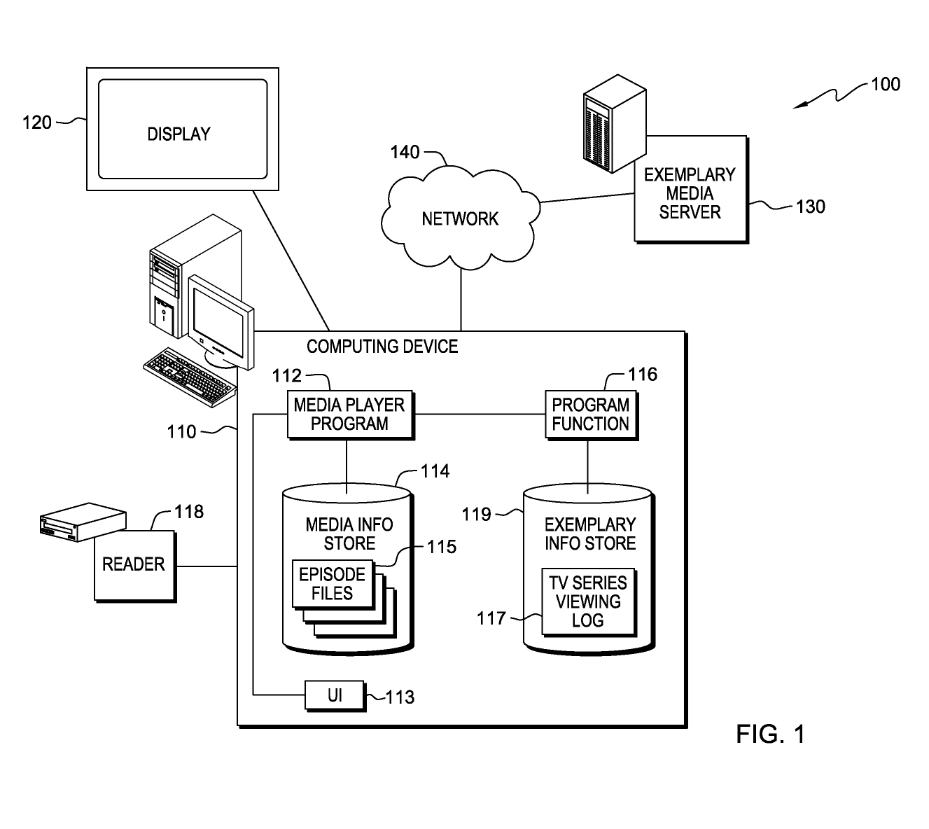

Embodiments of the present invention will now be described in detail with reference to the Figures. FIG. 1 is a block diagram illustrating an environment, generally designated 100, in accordance with one embodiment of the present invention.

Environment 100 includes reader 118, display 120, exemplary media server 130, and computing device 110. Display 120, exemplary media server 130, and computing device 110 are interconnected over network 140. Network 140 can be, for example, a local area network (LAN), a wide area network (WAN) such as the Internet, or a combination of the two, and can include wired, wireless, or fiber optic connections. In general, network 140 can be any combination of connections and protocols that will support communications between computing device 110 and exemplary media server 130, in accordance with an embodiment of the present invention. Reader 118 is in communication with computing device 110. Reader 118 is hardware that reads information, such as multimedia files and/or associated metadata, stored on an optical disc, for example, a CD-ROM, DVD, or Blu-ray disc. Reader 118 transmits information that it has read to media player program 112 for execution.

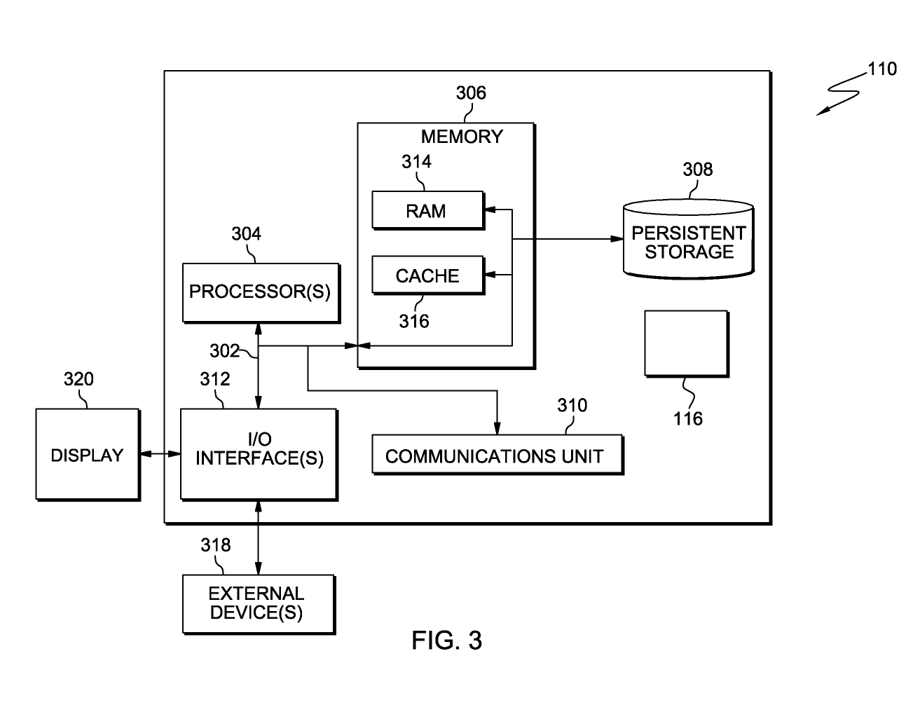

In various embodiments of the present invention, computing device 110 and exemplary media server 130 may be a laptop computer, tablet computer, netbook computer, personal computer (PC), a desktop computer, a personal digital assistant (PDA), or a smart phone. Exemplary media server 130 is in communication with computing device 110 via network 140. Exemplary media server 130 is a computing device that provides digital media, such as one or more television series episodes (hereinafter “episode”), in accordance with an embodiment of the present invention. A television series (hereinafter “series”) is a connected set of television program episodes that run under the same title, possibly spanning many seasons. Exemplary media server 130 transmits, via network 140, at least one episode multimedia file and/or associated metadata to computing device 110. In an embodiment, exemplary media server 130 transmits, via network 140, one or more episode multimedia files to computing device 110 for viewing, for example, via display 120. In another embodiment, exemplary media server 130 provides episode multimedia files that are associated with a streaming digital media content provider, such as YouTube®, Hulu® or Netflix®. Display 120 is in communication with computing device 110. Display 120 is an output device that presents information in a visual form. Display 120 presents information received from computing device 110. In an embodiment, display 120 includes the features of display 320 (discussed below in further detail in reference to FIG. 3).

Computing device 110 is in communication with reader 118 and display 120. Computing device 110 is a computing device that is utilized for playback of episode multimedia files. In various embodiments of the present invention, computing device 110 includes user interface 113, media player program 112 and program function 116. In other embodiments, computing device 110 may include internal and external hardware components, as depicted and described in further detail with respect to FIG. 3. Media player program 112 is in communication with user interface 113, media information store 114 and program function 116. User interface 113 typically is a graphical user interface (GUI) that is presented on a display, such as display 120.

User interface 113 may also include navigation menus and other graphical elements that a user may utilize, via, for example, a keyboard, keypad, a touch screen, audio and/or some other suitable input device. User interface 113 may be a textual user interface. In general, user interface 113 may be any user interface, for example, a mouse, keyboard, speech/sound based, or touch-screen display, that allows a user to generate signals sufficient to access and manipulate media player program 112. Media information store 114 is an information repository that includes episode multimedia files, such as episode files 115. Episode files 115 are episode multimedia files that include one or more episodes of one or more series. In another embodiment, media information store 114 includes metadata associated with the one or more episode multimedia files included in episode files 115.

Media player program 112 is software that can execute (hereinafter “play”) episode multimedia files. Media player program 112 can play episode multimedia files included in episode files 115, read by reader 118, and/or transmitted by exemplary media server 130.

Exemplary information store 119 is in communication with program function 116. Exemplary information store 119 is an information repository that includes television series viewing log 117. Television series viewing log 117 includes viewing metrics associated with one or more episode multimedia files played by media player program 112. For example, viewing metrics included in television series viewing log 117 include one or more of an episode related viewing date/time, episode title, percent viewed, and series title.

Program function 116 is in communication with media player program 112 and exemplary information store 119. Program function 116 represents software that determines the first unviewed episode in a series when series playback, via an optical disc, is enabled. Program function 116 instructs media player program 112 to play episode multimedia files that are included in episode files 115, read by reader 118, and/or transmitted by exemplary media server 130. Program function 116 can store viewing metrics in a television series viewing log, for example, television series viewing log 117 included in exemplary information store 119.

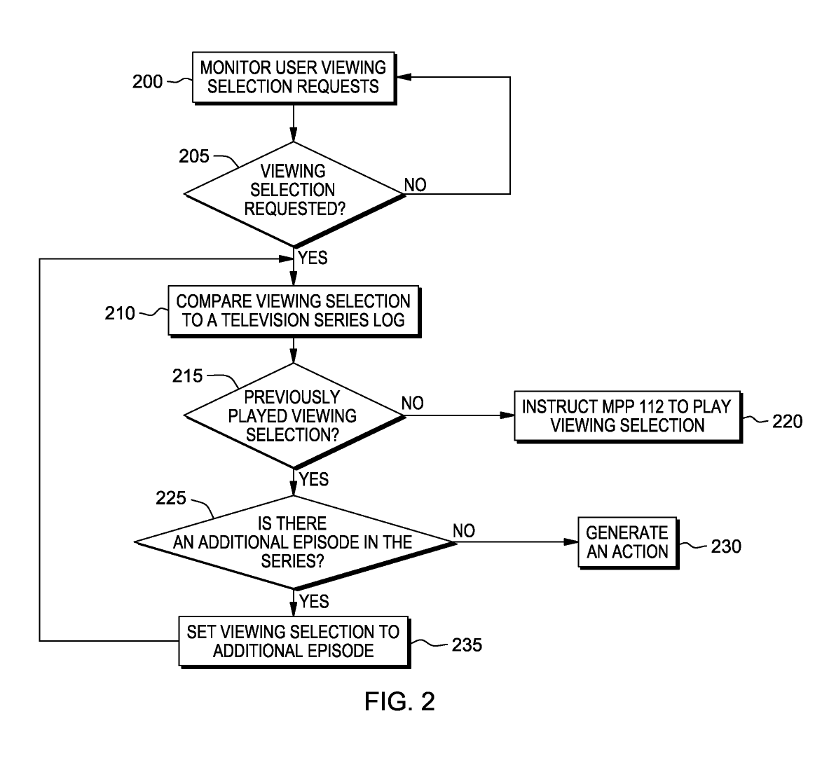

Program function 116 determines whether an episode multimedia file has been previously played by media player program 112. Program function 116 monitors each episode multimedia file played by media player program 112 (hereinafter “viewing selection”). Program function 116 generates an action in response to determining that a viewing selection has been previously played by media player program 112. The action generated by program function 116 is discussed in further detail in reference to FIG. 2.

FIG. 2 is a flowchart depicting operational steps of program function 116 for determining whether an episode multimedia file included on an optical disc has previously been played, in accordance with an embodiment of the present invention. Program function 116 monitors user viewing selection requests (step 200). For example, program function 116, determines that an optical disc is inserted in reader 118 and that season playback is desired by the user of computing device 110. Program function 116 monitors user viewing selection requests received by media player program 112 via user interface 113. In response to determining that a viewing selection has not been selected (“no” branch decisional 205), program function 116 returns to step 200. When a viewing selection is requested (“yes” branch decisional 205) program function 116 compares the viewing selection to a television series viewing log (step 210). For example, program function 116 compares the viewing selection to a television series viewing log by comparing the metadata of the episode multimedia file that is associated with the viewing selection to the information included in television series viewing log 117.

Program function 116 determines whether the viewing selection has been previously played (decisional 210). If program function 116 determines that the viewing selection was not previously played (“no” branch decisional 215), then program function 116 instructs media player 112 to play the viewing selection (step 220). For example, program function 116 determines that the viewing selection was not previously played by accessing the information included in television series viewing log 116 and determining that there is no associated information included therein or the associated percent viewed information included therein is less than one-hundred (100) percent.

If there is no associated information included therein or the viewing selection's percent viewed information is less than one-hundred (100) percent, then program function 116 instructs media player 112 to play the viewing selection either from the beginning of the viewing selection or from a viewing location reflected by the determined percent viewed. In an embodiment, media player 112 plays a viewing selection by executing executable code included in the episode multimedia file or a copy thereof.

If program function 116 determines that the viewing selection was not previously played, for example, by media player program 112 (“no” branch decisional 215), then program function 116 instructs media player program 112 (referred to as MPP 112 in FIG. 2) to play the viewing selection (step 220).

If program function 116 determines that the viewing selection was previously played, for example, by media player program 112 (“yes” branch decisional 215), then program function 116 determines whether there is an additional episode in the series (decisional 225). If program function 116 determines that there is not an additional episode in the series (“no” branch decisional 225), then program function 116 generates an action (step 230). For example, if program function 116 determines that the percentage of viewed information associated with the viewing selection, included in television series log 117, is one-hundred (100) percent, then program function 116 generates an action. In an embodiment, the action generated by program function 116 includes instructing media player program 112 to play the multimedia file on the optical disc that is associated with the initial episode of the television series.

In another embodiment, the action generated by program function 116 includes program function 116 displaying, via display 120, a notice that, for example, all episodes in the television series have been viewed by the user of computing device 110. In yet another embodiment, the action generated by program function 116 includes program function 116 generating a viewing history of the television series associated with the viewing selection for display, for example, vie display 120. For example, program function 116 generates a viewing history of the television series associated with the viewing selection by determining, for example, viewing date/time of all episodes of the series associated with the viewing selection, included in television viewing log 117.

In yet still another embodiment, the action generated by program function 116 includes program function 116 generating a summary of the episode and/or series associated with the viewing selection. In an embodiment, program function 116 generates the summary by determining the summary of episode multimedia file included in the associated metadata included on the optical disc. In another embodiment, program function 116 generates the summary by instructing media player program 112 to retrieve the summary of episode multimedia files associated with the viewing selection from exemplary media server 130. If program function 116 determines that there is an additional episode included in the series that is associated with the viewing selection (“yes” branch of decisional 225), then program function 116 sets the viewing selection to the additional episode (step 235) and proceeds to step 210.

FIG. 3 depicts a block diagram of components of computing device 110 in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computing device 110 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Program function 116, media player program 112, media information store 114, and exemplary information store 119 are stored in persistent storage 308 for execution and/or access by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including exemplary media server 130. In these examples, communications unit 310 includes one or more network interface cards. Communications unit 310 may provide communications through the use of either or both physical and wireless communications links. Program function 116 and media player program 116 may be downloaded to persistent storage 308 through communications unit 310.

I/O interface(s) 312 allows for input and output of data with other devices that may be connected to server computer 102. For example, I/O interface 312 may provide a connection to external devices 318 such as a keyboard, keypad, a touch screen, reader 118, and/or some other suitable input device. External devices 318 can also include portable computer-readable storage media such as, for example, thumb drives, portable optical or magnetic disks, and memory cards. Software and data used to practice embodiments of the present invention, e.g., program function 116, media player program 112, episode files 115, and television series viewing log 117, can be stored on such portable computer-readable storage media and can be loaded onto persistent storage 308 via I/O interface(s) 312. I/O interface(s) 312 also connects to a display 320 and/or display 120. Similar to display 120, display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method comprising:
monitoring, via a computing device, a viewing selection of an episode multimedia file, wherein the episode multimedia file is included as executable code on an optical disc, and wherein the episode multimedia file is associated with a television series;
determining whether the episode multimedia file or a copy thereof has been previously executed;
transmitting the episode multimedia file for display, in response to determining that the episode multimedia file or a copy thereof was not previously executed; and
generating an action, in response to determining that the episode multimedia file or copy thereof was previously executed.

2. The method of claim 1, wherein determining whether the episode multimedia file or a copy thereof has been previously executed includes comparing metadata associated with the episode multimedia file to a television series viewing log.

3. The method of claim 2, wherein the metadata associated with the episode multimedia file reflects one or more of the following:
television series title;
episode title;
episode number;
disc number; and
percent viewed.

4. The method of claim 2, wherein the television series viewing log includes information associated with an episode multimedia file that reflects one or more of the following:
television series title;
episode title;
episode number;
disc number; and
percent viewed.

5. The method of claim 1, wherein the generating an action includes one or more of the following:
transmitting an episode multimedia file that includes an initial episode of the television series for display;
generating a notice that all episodes in the television series have been viewed;
generating a viewing history of the television series for display; and
generating a summary of the series and/or an episode included therein for display.

6. The method of claim 1, wherein the episode multimedia file or the copy thereof was previously executed by another computing device.

7. A computer program product, the computer program product comprising a computer readable storage medium having program code embodied therewith, the program code executable by a processor to:
monitor a viewing selection of an episode multimedia file, wherein the episode multimedia file is included as executable code on an optical disc, and wherein the episode multimedia file is associated with a television series;
determine whether the episode multimedia file or a copy thereof has been previously executed;
transmit the episode multimedia file for display, in response to a computing device that includes the processor determining that the episode multimedia file or a copy thereof was not previously executed; and
generate an action, in response to a computing device that includes the processor determining that the episode multimedia file or copy thereof was previously executed.

8. The computer program product of claim 7, wherein the computer code to determine whether the episode multimedia file or the copy thereof has been previously executed further includes computer code to compare metadata associated with the episode multimedia file to a television series viewing log.

9. The computer program product of claim 8, wherein the metadata associated with the episode multimedia file reflects one or more of the following:
television series title;
episode title;
episode number;
disc number; and
percent viewed.

10. The computer program product of claim 8, wherein the television series viewing log includes information that reflects one or more of the following:
television series title;
episode title;
episode number;
disc number; and
percent viewed.

11. The computer program product of claim 7, wherein the computer code to generate an action further includes computer code to do one or more of the following:
transmit an episode multimedia file that includes an initial episode of the television series for display;
generate a notice that all episodes in the television series have been viewed;
generate a viewing history of the television series for display; and
generate a summary of the series and/or an episode included therein for display.

12. The computer program product of claim 7, wherein the episode multimedia file or the copy thereof was not previously executed by the processor.

13. A computer system comprising:
one or more computer processors;
one or more computer-readable storage media;
program instructions stored on the computer-readable storage media for execution by at least one of the one or more processors, the program instructions comprising:
program instructions to monitor a viewing selection of an episode multimedia file, wherein the episode multimedia file is included as executable code on an optical disc, and wherein the episode multimedia file is associated with a television series;
program instructions to determine whether the episode multimedia file or a copy thereof has been previously executed;
program instructions to transmit the episode multimedia file for display, in response to a computing device that includes the one or more processors determining that the episode multimedia file or a copy thereof was not previously executed; and
program instructions to generate an action, in response to a computing device that includes the one or more processors determining that the episode multimedia file or copy thereof was previously executed.

14. The computer system of claim 13, wherein the program instructions to determine whether the episode multimedia file or the copy thereof has been previously executed further includes program instructions to compare metadata associated with the episode multimedia file to a television series viewing log.

15. The computer system of claim 14, wherein the metadata associated with the episode multimedia file reflects one or more of the following:
television series title;
episode title;
episode number;
disc number; and
percent viewed.

16. The computer system of claim 14, wherein the television series viewing log includes information that reflects one or more of the following:
television series title;
episode title;
episode number;
disc number; and
percent viewed.

17. The computer system of claim 13, wherein the program instructions to generate an action further include program instructions to do one or more of the following:
transmit an episode multimedia file that includes an initial episode of the television series for display;
generate a notice that all episodes in the television series have been viewed;
generate a viewing history of the television series for display; and
generate a summary of the series and/or an episode included therein for display.

18. The computer system of claim 13, wherein the episode multimedia file or the copy thereof was not previously executed by the one or more processors.
